(19) United States
(12) Patent Application Publication
(10) Pub. No.: US 2024/0013670 A1
(43) Pub. Date: Jan. 11, 2024

(54) INFORMATION PROCESSING APPARATUS, INFORMATION PROCESSING METHOD, AND INFORMATION PROCESSING PROGRAM

(71) Applicant: Sony Group Corporation, Tokyo (JP)

(72) Inventors: Yasuhiro HORI, Kanagawa (JP); Ko KOBAYASHI, Tokyo (JP); Takashi ISOZAKI, Kanagawa (JP); Seigo TANIGUCHI, Kanagawa (JP); Hiroaki IMAGAWA, Tokyo (JP)

(73) Assignee: Sony Group Corporation, Tokyo (JP)

(21) Appl. No.: 18/037,718

(22) PCT Filed: Nov. 22, 2021
(86) PCT No.: PCT/JP2021/042742

§ 371 Date: May 18, 2023

(30) Foreign Application Priority Data
Dec. 1, 2020 (JP) 2020-199770

(51) Int. Cl. G09B 7/00; G06Q 50/20

(52) U.S. Cl. CPC G09B 7/00; G06Q 50/20

(57) ABSTRACT

An information processing apparatus (1) includes a generation unit (32) and an estimation unit (33). The generation unit (32) generates pieces of divided data by dividing pieces of time series data related to a predetermined analysis target for each predetermined period. The estimation unit (33) estimates relation between pieces of data included in the divided data generated by the generation unit (32).

### FIELD

The present disclosure relates to an information processing apparatus, an information processing method, and an information processing program.

### BACKGROUND

For example, in the field of education, it is important to consider the cause of why a student erroneously answered a question. In such a point, for example, there is a technique of estimating a question of which year in the past a question of the current year is related to by analyzing test results taken by the student in each year as pieces of time series data.

### CITATION LIST

### Patent Literature

Patent Literature 1: WO 2016/103611

### SUMMARY

### Technical Problem

The above-described technique, however, does not provide relation useful for, for example, a student who desires to conduct a review while gradually looking back on years, and cannot be said to provide high accuracy of estimating relation. For example, when a quite basic question learned in an elementary school is related to an application question for a junior high school student or a high school student, that is, when relation in which the order of gradually built learnings is not considered appears, the relation cannot be said to be useful for the student.

Therefore, the present disclosure proposes an information processing apparatus, an information processing method, and an information processing program capable of enhancing accuracy of estimating relation between pieces of time series data.

### Solution to Problem

An information processing apparatus includes a generation unit and an estimation unit. The generation unit generates pieces of divided data by dividing pieces of time series data related to a predetermined analysis target for each predetermined period. The estimation unit estimates relation between pieces of data included in the divided data generated by the generation unit.

### BRIEF DESCRIPTION OF DRAWINGS

FIG. 1 illustrates an outline of an information processing method according to an embodiment of the present disclosure.

FIG. 2 illustrates a configuration example of an information processing system according to the embodiment.

FIG. 3 is a block diagram illustrating a configuration of a terminal device according to the embodiment.

FIG. 4 is a block diagram illustrating a configuration of the information processing apparatus according to the embodiment.

FIG. 5 illustrates one example of time series data.

FIG. 6 illustrates one example of user information.

FIG. 7A illustrates processing of generating a question model.

FIG. 7B illustrates the processing of generating a question model.

FIG. 8 illustrates one example of screen display of a question model.

FIG. 9 illustrates one example of the screen display of a question model.

FIG. 10 illustrates one example of the screen display of a question model.

FIG. 11 is a flowchart illustrating a procedure of information processing executed by the information processing apparatus according to the embodiment.

FIG. 12 is a flowchart illustrating the procedure of information processing executed by the information processing apparatus according to the embodiment.

FIG. 13 is a flowchart illustrating the procedure of information processing executed by the information processing apparatus according to the embodiment.

FIG. 14 is a block diagram illustrating one example of a hardware configuration of the information processing apparatus according to the present embodiment.

### DESCRIPTION OF EMBODIMENTS

An embodiment of the present disclosure will be described in detail below with reference to the drawings. Note that, in the following embodiment, the same reference signs are attached to the same parts to omit duplicate description.

Furthermore, in the present specification and the drawings, a plurality of components having substantially the same functional configuration may be distinguished by attaching different numbers after the same reference signs. Note, however, that, when it is unnecessary to particularly distinguish a plurality of components having substantially the same functional configuration, only the same reference signs are attached.

Furthermore, the present disclosure will be described in accordance with the following item order.

1. Outline of Information Processing Method

2. Configuration of Information Processing System According to Embodiment

3. Configuration of Terminal Device According to Embodiment

4. Configuration of Information Processing Apparatus According to Embodiment

5. Variations

6. Flowchart

7. Hardware Configuration Example

8. Conclusion

### 1. Outline of Information Processing Method

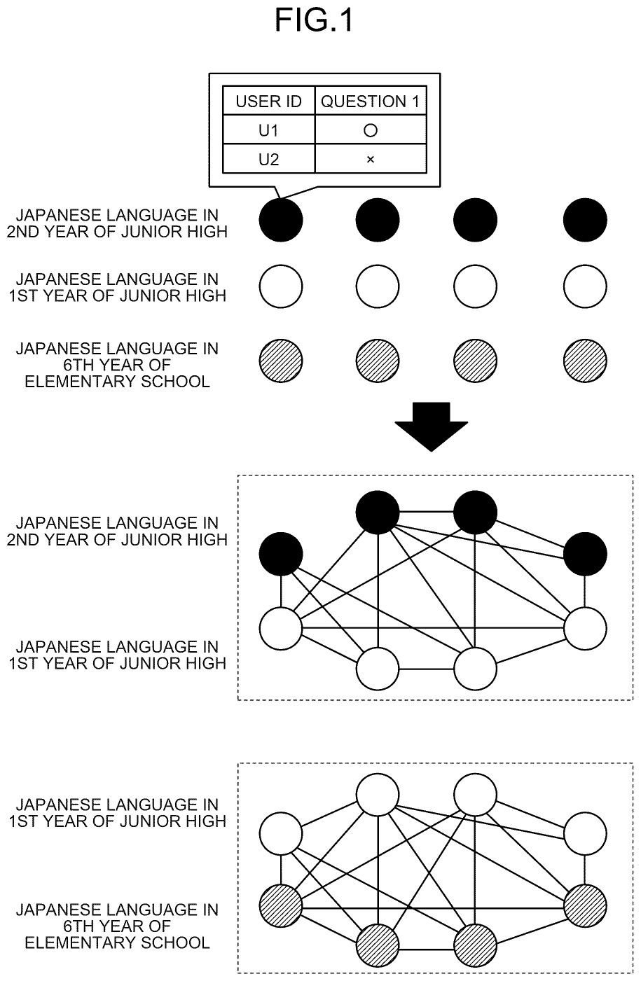

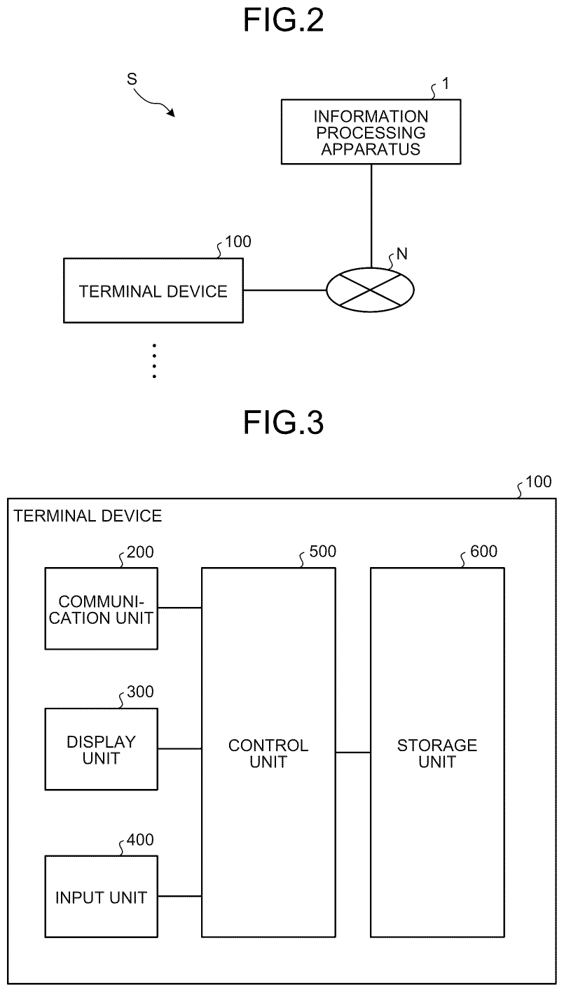

First, an outline of an information processing method according to the embodiment will be described with reference to FIG. 1. FIG. 1 illustrates the outline of the information processing method according to the embodiment of the present disclosure. Note that FIG. 1 illustrates the outline of the information processing method, and details of an information processing apparatus, the information processing method, and an information processing program will be described later with reference to FIG. 2 and subsequent drawings.

The information processing method according to the embodiment is adopted to estimate inter-data relation, such as correlation and causality, between pieces of time series data on a predetermined analysis target and provide various types of service based on the estimation result. Note that, in the following embodiment, a case where the information processing method is applied to the field of education will be described in an example.

Furthermore, FIG. 1 illustrates a case where comprehension levels in learning of students belonging to an educational facility such as a school are set as analysis targets. Note that the educational facility is not limited to a public facility such as a school, and may be, for example, a private facility such as a cram school or an educational institution having no physical facility such as an institution that provides online education. Furthermore, FIG. 1 illustrates, in an example, a case where the piece of time series data are results of tests of Japanese language taken by the students for three years from the sixth year of elementary school to the second year of junior high school.

Note that, in FIG. 1, figures illustrate the pieces of time series data, and one circle figure indicates one question in a test. Furthermore, time series data includes correct/incorrect results for questions of students.

The time series data in FIG. 1 indicates that a student identified by a user ID “U1” correctly answered “Question 1” in a test of Japanese language in the second year of junior high school (2nd year of junior high) and a student identified by a user ID “U2” erroneously answered “Question 1”. That is, in FIG. 1, questions of Japanese language taken in respective years and correct/incorrect results for the questions are accumulated as pieces of time series data for each student.

Here, in the field of education, it is important to consider why a student erroneously answered a question. That is, for the erroneously answered question, it is necessary to consider in which learning field among learning fields built so far a comprehension level is low (misstep is made). In this regard, for example, there is a technique of grasping a past question related to the erroneously answered question by estimating the relation between questions.

When pieces of time series data including test results of three years are collectively analyzed, however, such a technique may present relation in which the order of learnings gradually built by learnings of respective years is not considered. In such relation, for example, a quite basic question is associated with a most recent erroneously answered question. In such a case, a student may have difficulty in gradually conducting a review while looking back on the past.

That is, when the pieces of time series data are collectively analyzed, relation in which the time order of pieces of time series data is not considered is estimated. The relation cannot be said to be a useful estimation result for a user, and accuracy of estimating relation cannot be said to be high.

Therefore, in the information processing method according to the embodiment, pieces of time series data are divided for each predetermined period, and relation between the divided pieces of data is estimated. Specifically, as illustrated in FIG. 1, in the information processing method, first, pieces of time series data on a predetermined analysis target are acquired. Pieces of divided data are generated by dividing the pieces of acquired time series data for each predetermined period.

In FIG. 1, in the information processing method, pieces of divided data are generated by dividing pieces of time series data for every two years. The pieces of time series data are test results of three years from the sixth year of elementary school (6th year of elementary school) to the second year of junior high school (2nd year of junior high). Specifically, pieces of divided data are generated such that the periods thereof partially overlap with each other. That is, in the example of FIG. 1, in the information processing method, the pieces of time series data are divided into divided data including time series data of the 2nd year of junior high and the 1st year of junior high and divided data including time series data of the 1st year of junior high and the 6th year of elementary school.

Subsequently, in the information processing method according to the embodiment, inter-data relation between pieces of time series data included in the generated divided data is estimated. For example, in FIG. 1, in the information processing method, relation in the same year (2nd year of junior high to 2nd year of junior high and 1st year of junior high to 1st year of junior high) and relation in different years (2nd year of junior high to 1st year of junior high) in the divided data including the 2nd year of junior high and the 1st year of junior high are estimated. Furthermore, in the information processing method, relation in the same year (1st year of junior high to 1st year of junior high and 6th year of elementary school to 6th year of elementary school) and relation in different years (1st year of junior high to 6th year of junior high) in the divided data including the 1st year of junior high and the 6th year of elementary school are estimated. Note that the relations are estimated based on, for example, partial correlation between questions, and details of such a point will be described later.

That is, in the information processing method according to the embodiment, inter-data relation within a divided period in divided data is estimated, so that, for example, relation in which a time order of a time series is not considered does not appear. This limits a question in relation to a question erroneously answered by a student to a most recent question, for example, so that the student can conduct a review while gradually looking back on the past from the most recent question.

That is, according to the information processing method of the embodiment, relation useful for a user such as a student can be estimated, so that accuracy of estimating the relation between pieces of time series data can be enhanced.

### 2. Configuration of Information Processing System According to Embodiment

Next, a configuration example of an information processing system according to the embodiment will be described with reference to FIG. 2. FIG. 2 illustrates the configuration example of the information processing system according to the embodiment. In an information processing system S according to the embodiment in FIG. 2, an information processing apparatus 1 and a plurality of terminal devices 100 are communicably connected via a predetermined communication network N.

The information processing apparatus 1 is configured as, for example, a server device, and executes the above-described information processing method. The information processing apparatus 1 transmits and receives various pieces of information to and from the terminal devices 100 via the communication network N.

The terminal devices 100 are used by users such as students and teachers. For example, the terminal devices 100 are implemented by, for example, a smartphone, a tablet terminal, a notebook personal computer (PC), a desktop PC, a mobile phone, and a personal digital assistant (PDA).

### 3. Configuration of Terminal Device According to Embodiment

Next, a configuration of a terminal device 100 according to the embodiment will be described with reference to FIG. 3. FIG. 3 is a block diagram illustrating a configuration of the terminal device 100 according to the embodiment. As illustrated in FIG. 3, the terminal device 100 includes a communication unit 200, a display unit 300, an input unit 400, a control unit 500, and a storage unit 600.

The communication unit 200 is implemented by, for example, a network interface card (NIC). Then, the communication unit 2 transmits and receives information to and from the information processing apparatus 1 via the communication network N.

The display unit 300 is, for example, a display that displays various pieces of information. For example, the display unit 300 displays information received from the information processing apparatus 1 under the control of the control unit 500.

The input unit 400 includes, for example, a keyboard and a mouse, and receives input operations of various pieces of information from a user. Note that the display unit 300 and the input unit 400 may be configured separately. The display unit 300 and the input unit 400 may be integrally configured like, for example, a touch panel display.

Here, the terminal device 100 includes a computer including, for example, a central processing unit (CPU), a read only memory (ROM), a random access memory (RAM), a hard disk, and an input/output port and various circuits.

The CPU of the computer functions as the control unit 500 by, for example, reading and executing a program stored in the ROM. Furthermore, at least some or all of the functions of the control unit 500 can be configured by hardware such as an application specific integrated circuit (ASIC) and a field programmable gate array (FPGA). Furthermore, the storage unit 600 corresponds to, for example, the RAM or the hard disk. The RAM and the hard disk can store information of various programs and the like. Note that the terminal device 100 may acquire the above-described programs and various pieces of information via another computer or a portable recording medium connected via a wired or wireless network.

For example, the control unit 500 acquires time series data input via the input unit 400, and transmits the time series data to the information processing apparatus 1 via the communication unit 200. Note that the control unit 500 may transmit the time series data to the information processing apparatus 1, and store the time series data in the storage unit 600.

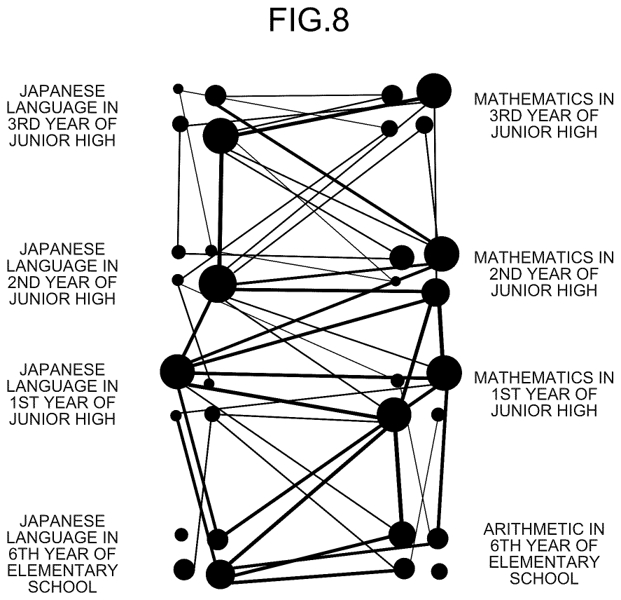

Furthermore, the control unit 500 receives an analysis result of the time series data from the information processing apparatus 1, and displays the analysis result on the display unit 300. Note that details of information displayed on the display unit 300 will be described later with reference to FIGS. 8 to 10.

### 4. Configuration of Information Processing Apparatus According to Embodiment

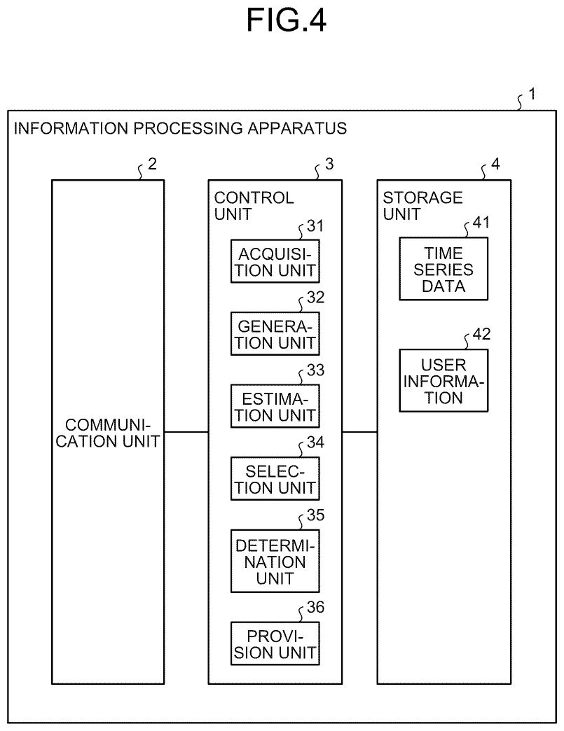

Next, a configuration of the information processing apparatus 1 according to the embodiment will be described with reference to FIG. 4. FIG. 4 is a block diagram illustrating a configuration of the information processing apparatus 1 according to the embodiment. As illustrated in FIG. 4, the information processing apparatus 1 includes a communication unit 2, a control unit 3, and a storage unit 4. The communication unit 2 is implemented by, for example, an NIC. Then, the communication unit 2 transmits and receives information to and from the terminal device 100 via the communication network N.

The control unit 3 includes an acquisition unit 31, a generation unit 32, an estimation unit 33, a selection unit 34, a determination unit 35, and a provision unit 36. The storage unit 4 stores time series data 41 and user information 42.

Here, the information processing apparatus 1 includes a computer including, for example, a central processing unit (CPU), a read only memory (ROM), a random access memory (RAM), a hard disk, and an input/output port and various circuits.

The CPU of the computer functions as the acquisition unit 31, the generation unit 32, the estimation unit 33, the selection unit 34, the determination unit 35, and the provision unit 36 of the control unit 3 by, for example, reading and executing a program stored in the ROM.

Furthermore, at least one or all of the acquisition unit 31, the generation unit 32, the estimation unit 33, the selection unit 34, the determination unit 35, and the provision unit 36 of the control unit 3 may be configured by hardware such as an application specific integrated circuit (ASIC) and a field programmable gate array (FPGA).

Furthermore, the storage unit 4 corresponds to, for example, the RAM or the hard disk. The RAM and the hard disk can store the time series data 41, the user information 42, information of various programs, and the like. Note that the information processing apparatus 1 may acquire the above-described programs and various pieces of information via another computer or a portable recording medium connected via a wired or wireless network.

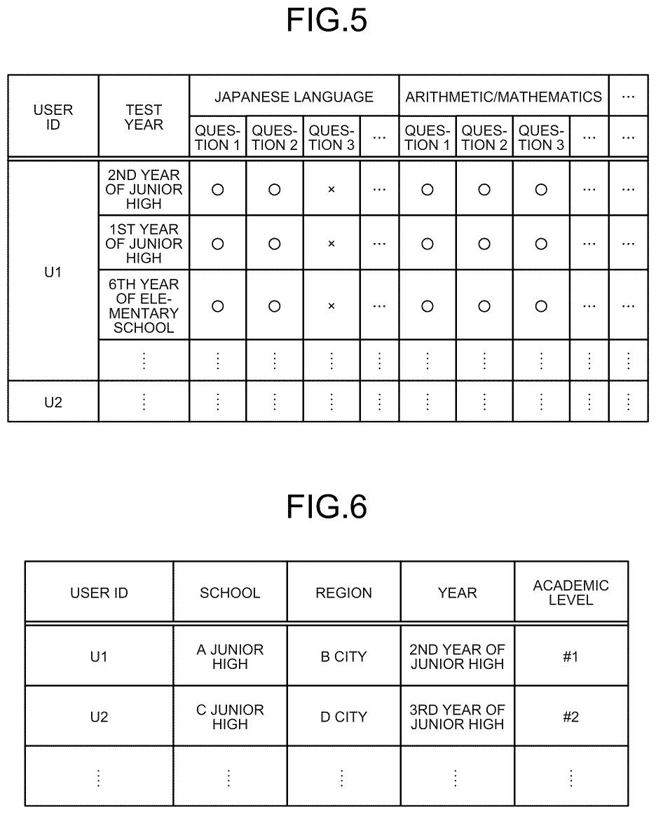

The time series data 41 is related to a predetermined analysis target. FIG. 5 illustrates one example of the time series data. Note that FIG. 5 illustrates time series data on test results of students in one example.

As illustrated in FIG. 5, the time series data 41 includes items such as “user ID”, “test year”, “Japanese language”, and “arithmetic/mathematics”. “User ID” is identification information for identifying a student who is a user. “Test year” is information indicating a year in which the student took a test, in other words, information on data interval between pieces of time series data.

“Japanese language” and “arithmetic/mathematics” are information indicating the test results, and are information indicating correct/incorrect results for each question. In other words, “Japanese language” and “arithmetic/mathematics” are information on data types in the time series data.

Note that the time series data in FIG. 5 is one example, and, for example, metadata of each question may be further included. The metadata is information such as the difficulty level of a question, the intent of the question, an outline of the question, and a question format.

Next, the user information 42 is related to a user corresponding to time series data, and is input by the user via the terminal device 100. FIG. 6 illustrates one example of the user information 42. As illustrated in FIG. 6, the user information 42 includes items such as “user ID”, “school”, “region”, “year”, and “academic level”.

“User ID” is identification information for identifying a student who is a user. “School” is information on a name of a school to which the student belongs, in other words, a name of an educational facility to which the user belongs. “Region” is information on the location of “school”. “Year” is information indicating the current year of the student. “Academic level” is information indicating an academic level of the student, and includes, for example, a deviation value and an average value.

Next, each functional block (acquisition unit 31, generation unit 32, estimation unit 33, selection unit 34, determination unit 35, and provision unit 36) of the control unit 3 will be described.

The acquisition unit 31 acquires various pieces of information. The acquisition unit 31 acquires time series data related to a predetermined analysis target. Specifically, the acquisition unit 31 acquires time series data on a comprehension level of each of a plurality of students belonging to an educational facility.

The time series data is, for example, a result of a test taken by a student. Specifically, the time series data includes correct/incorrect results of a plurality of questions answered by the student in the test. Note that the test included in the time series data may be a nationally standardized test in which the same questions are answered across the country or a test uniquely conducted by each school. Furthermore, such a test may be conducted once a year or a plurality of times a year. Note that, although, in FIG. 1, the test results of Japanese language are illustrated as the pieces of time series data, other subjects such as arithmetic, mathematics, and English may be mixed as the pieces of time series data.

Furthermore, although the time series data can be acquired by, for example, being input by a teacher via the terminal device 100, the time series data may be acquired from, for example, a server device storing the test results.

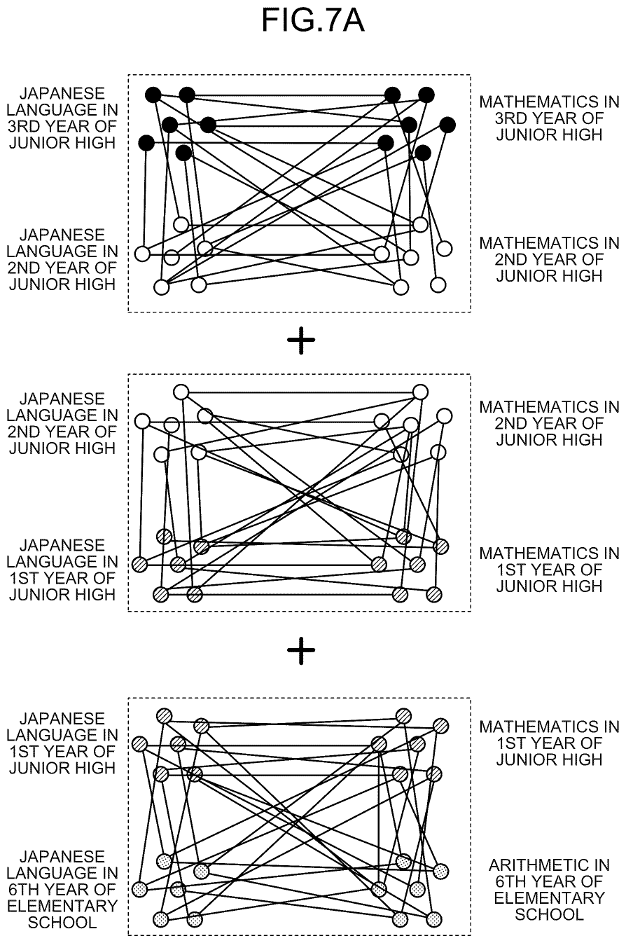

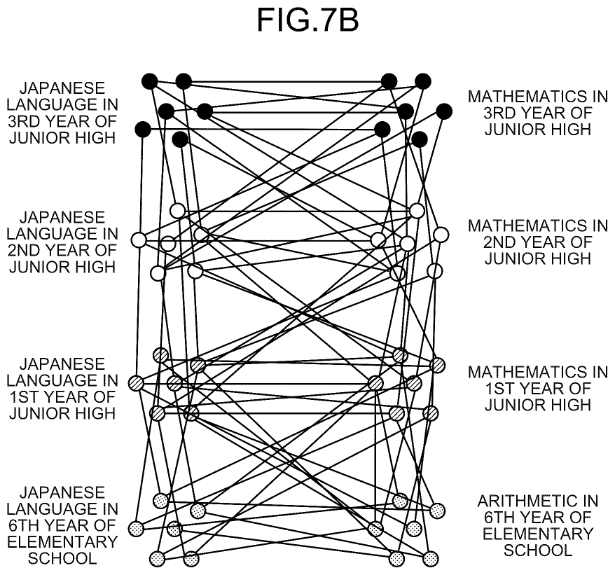

The generation unit 32 generates pieces of divided data by dividing the pieces of time series data acquired by the acquisition unit 31 for each predetermined period. For example, the generation unit 32 generates pieces of divided data by dividing the pieces of time series data including test results for a plurality of years for every two years. Note that the generation unit 32 divides the pieces of time series data such that the periods of pieces of divided data partially overlap with each other, and such a point will be described later with reference to FIG. 7A.

Note that a period of divided data is not limited to two years, and may be three years or more or less than one year (e.g., every half year) as long as the period corresponds to an educational unit of an educational facility. Furthermore, the educational unit is not limited to the year unit, and may be, for example, a term unit or a school unit (e.g., elementary school, junior high school, and high school).

Furthermore, the period of the divided data generated by the generation unit 32 may be designated by a user via the terminal device 100, or may be preliminarily fixed.

Furthermore, after classifying pieces of time series data for each attribute of the student, the generation unit 32 may generate pieces of divided data for each classified time series data. The attribute of the student includes, for example, a school, a region, and an academic level. As a result, divided data for students having similar features of academic achievement and the like can be generated, so that features of the students can be reflected with high accuracy in relation estimated by the estimation unit 33 in the subsequent stage.

The estimation unit 33 estimates inter-data relation between pieces of time series data included in the divided data generated by the generation unit 32. For example, the estimation unit 33 estimates the relation by correlation analysis in which each question included in the divided data is set as a variable and a correct/incorrect result of the question is set as a value of the variable. Various correlation functions such as the CORREL function, the PEARSON function, and a partial correlation can be used for the correlation analysis.

For example, when divided data includes test results for two years, the estimation unit 33 estimates relation between questions in different years or relation between questions in the same year. That is, the estimation unit 33 estimates relation between all the questions included in the divided data. Furthermore, the estimation unit 33 calculates, for each question, a sum of amounts of correlation with another question having relation (correlation). Note that the sum of the correlation amounts is used when screen display to be described later is performed.

Furthermore, after estimating relations in pieces of divided data, the estimation unit 33 generates a question model by combining estimation results of the pieces of divided data. Such a point will be described with reference to FIGS. 7A and 7B.

FIGS. 7A and 7B illustrate processing of generating the question model. Note that FIGS. 7A and 7B illustrate a case where pieces of time series data include test results of Japanese language and arithmetic (mathematics) from the 6th year of elementary school to the 3rd year of junior high, that is, data on a comprehension level of each of a plurality of learning fields.

As illustrated in FIG. 7A, first, the generation unit 32 generates pieces of divided data by dividing test results of years from the 6th year of elementary school to the 3rd year of junior high for every two years. Specifically, the generation unit 32 generates the pieces of divided data divided such that periods of test results of one year among periods of test results of two years overlap with each other. That is, the generation unit 32 generates the pieces of divided data divided such that partial periods of predetermined periods overlap with each other.

In the example in FIG. 7A, the generation unit 32 generates divided data including test results of the 3rd year of junior high and the 2nd year of junior high, divided data including test results of the 2nd year of junior high and the 1st year of junior high, and divided data including test results of the 1st year of junior high and the 6th year of elementary school.

Then, the estimation unit 33 estimates relation for each divided data generated by the generation unit 32. Specifically, the estimation unit 33 estimates relation between pieces of time series data in the same learning field (Japanese language to Japanese language and mathematics to mathematics) and relation between pieces of time series data in different learning fields (Japanese language to mathematics). Note that FIG. 7A illustrates questions as nodes and relations as links. That is, a link connects questions having relation (having minimum value of correlation amount or partial correlation amount in combination of various variables equal to or more than predetermined threshold or p value of statistical test related thereto equal to or less than predetermined threshold).

Then, the estimation unit 33 combines estimation results indicating the relations in pieces of divided data based on pieces of time series data within the overlapping partial periods. Specifically, the estimation unit 33 generates the question model by combining the estimation results based on the test results of the 2nd year of junior high and the test results of the 1st year of junior high within the overlapping partial periods.

FIG. 7B illustrates the generated question model. As illustrated in FIG. 7B, relations between questions in the question model can be prevented from exceeding a year by combining pieces of divided data by overlapping periods. For example, according to the question model in FIG. 7B, a question of Japanese language of the 3rd year of junior high is limited to being associated with any of a question of mathematics of the 3rd year of junior high, a question of Japanese language of the 2nd year of junior high, and a question of mathematics of the 2nd year of junior high. A question of the 3rd year of junior high can be prevented from being associated with problems of the 1st year of junior high and the 6th year of elementary school.

This enables relation exceeding a year to be excluded, for example, when relation with any question is grasped, so that the relation with the question can be gradually grasped along a learning order. As a result, the provision unit 36 in the subsequent stage can gradually provide teaching materials along the learning order based on the question model, so that a student can learn gradually. Furthermore, not only the student himself/herself but an instructor such as a teacher can grasp a misstep point based on the question model and the correct/incorrect situation of a specific student, and the instructor can give learning advice to the specific student.

The selection unit 34 selects any student from a plurality of students as a target student. The provision unit 36 in the subsequent stage provides provision information to the target student.

For example, the selection unit 34 selects a student designated by the terminal device 100 as the target student. Furthermore, not only one but a plurality or students may be selected as target students.

For example, when the attribute of a student is designated, the selection unit 34 selects a plurality of students having the designated attribute as target students. For example, the selection unit 34 selects all the students at the same school or the same class as the target students.

The determination unit 35 determines an influence question among a plurality of questions in pieces of time series data. The influence question influences an erroneously answered question erroneously answered by the target students. Specifically, the influence question causes an erroneous answer for an erroneously answered question. That is, a low comprehension level for the learning field of the influence question increases the possibility of erroneously answering the erroneously answered question.

The determination unit 35 determines the influence question based on the estimation results from the estimation unit 33, that is, the question model. Specifically, first, the determination unit 35 reads correct/incorrect results of a target student from the time series data 41 stored in the storage unit 4.

Subsequently, the determination unit 35 selects a question model corresponding to the attribute of the target student, and maps (applies) the correct/incorrect results of the target student to the question model. Subsequently, the determination unit 35 selects any erroneously answered question from the correct/incorrect results. Selection of the erroneously answered question is received via, for example, the terminal device 100.

Note that the determination unit 35 may display information in which erroneously answered questions are arranged in descending order of correlation amounts for each subject (course), and such information may receive selection of the erroneously answered question. Alternatively, the determination unit 35 is not limited to receiving the selection of the erroneously answered question, but may automatically select an erroneously answered question having the highest correlation amount.

Then, the determination unit 35 extracts other questions having relation with the selected erroneously answered question. Then, the determination unit 35 determines, as an influence question, another question similar to metadata of the erroneously answered question (e.g., difficulty level and intent, outline, and question format of question) among the extracted other questions.

Note that the provision unit 36 in the subsequent stage provides, for example, teaching material information in a question format to a target student based on the influence question. The determination unit 35 performs processing in accordance with the correct/incorrect situation for questions of the target student.

For example, when the target student correctly answers a question based on the teaching material information, the determination unit 35 selects another erroneously answered question, and determines an influence question influencing the erroneously answered question. Alternatively, when the target student correctly answers the question based on the teaching material information, the determination unit 35 may determine a question having a higher difficulty level than the influence question or a question having the same difficulty level as an influence question. Note that the target student may determine which of the question having a higher difficulty level or the question having the same difficulty level is selected as the next influence question.

In contrast, when the target student erroneously answers the question based on the teaching material information, the determination unit 35 determines a question having a lower difficulty level than the influence question as an influence question.

Note that, although the question having a higher difficulty level is, for example, a question in the one-year higher year, the question may be, for example, a question having a value with a preset higher difficulty level. Furthermore, although the question having a lower difficulty level is, for example, a question in the one-year lower year, the question may be, for example, a question having a value with a preset lower difficulty level.

Next, processing of the determination unit 35 in a case where a plurality of target students is selected will be described.

Specifically, first, the determination unit 35 reads correct/incorrect results of a plurality of target students from the time series data 41 stored in the storage unit 4. Subsequently, the determination unit 35 selects a question model corresponding to the attribute of the plurality of target students, calculates a percentage of correct answers for each question from the correct/incorrect results of the plurality of target students, and maps (applies) the percentage of correct answers for each question to the selected question model.

Subsequently, the determination unit 35 extracts questions having a calculated percentage of correct answers less than a threshold, and extracts influence questions for the extracted questions.

Then, the determination unit 35 determines whether or not the extracted influence questions include an influence question having a percentage of correct answers less than a threshold. Then, the determination unit 35 notifies the provision unit 36 of the determination result.

The provision unit 36 provides teaching material information on the influence question determined by the determination unit 35. The teaching material information relates to, for example, a question in a question format similar to the influence question. Furthermore, the teaching material information may relate to a textbook range of the learning field corresponding to the influence question.

Furthermore, when the determination unit 35 determines that there is an influence question having a percentage of correct answers less than a threshold, the provision unit 36 provides, as teaching material information, information of advice that it is effective to learn a past learning region corresponding to the influence question.

Furthermore, when the determination unit 35 determines that there is no influence question having a percentage of correct answers less than a threshold, the provision unit 36 provides, as teaching material information, information of advice that it is effective to learn the current learning region.

Furthermore, the provision unit 36 displays information of a question model generated by the estimation unit 33 on a screen of the display unit 300 of the terminal device 100. That is, the provision unit 36 provides relation between a plurality of questions estimated by the estimation unit 33 by screen display. Here, a question model displayed on the screen of the display unit 300 will be specifically described with reference to FIGS. 8 to 10.

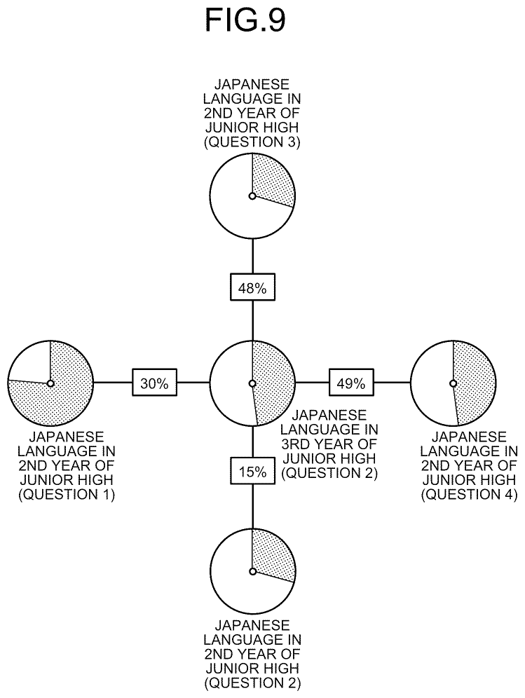

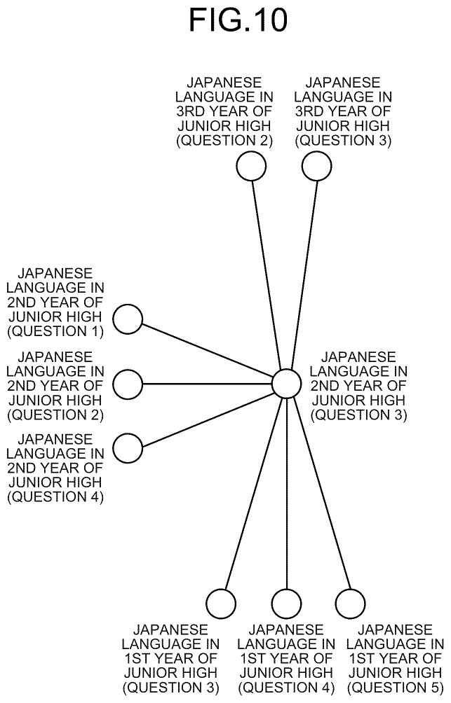

FIGS. 8 to 10 illustrate examples of screen display of the question model. Note that FIG. 8 is an example of a screen displaying the entire question model. FIG. 9 is an example of a screen to which a transition is made in a case where a predetermined question is designated in FIG. 8. FIG. 10 is a variation of the example of the screen in FIG. 8.

As illustrated in FIG. 8, in the example of the screen illustrating the entire question model, for example, one question is expressed as one point (referred to as node). Furthermore, questions having relation are connected by a line (referred to as link) connecting corresponding nodes.

Furthermore, the thickness of a link indicates the strength of the relation (magnitude of correlation amount). In FIG. 8, stronger relation (larger correlation amount) is expressed by a thicker link. Furthermore, the size of a node indicates the sum of the strengths of relations (sum of correlation amounts) of all the questions having relation. In FIG. 8, a larger sum of strengths of relations (larger sum of correlation amounts) is expressed by a larger node.

That is, the provision unit 36 provides the presence or absence of relation between a plurality of questions and the strength of the relation for screen display. A user can easily grasp the question model by the presence or absence of relation between questions, the strength of the relation, and the like expressed by visual changes as described above.

Note that the display mode in the screen example in FIG. 8 is merely one example. For example, the number of nodes having relation may be noted instead of the size of a node. Furthermore, instead of the thickness of a link, shading of the link may be used. That is, in the screen display, the provision unit 36 sets each of the plurality of questions as a node, connects questions having relation with a link, and expresses the link in a display mode in accordance with the strength of the relation.

Subsequently, when a user selects one node in FIG. 8, a transition is made to the screen example in FIG. 9. Note that FIG. 9 illustrates the screen example in a case where Question 2 of Japanese language of the 3rd year of junior high is selected.

As illustrated in FIG. 9, when one question is selected, the selected question is arranged at the center, and other questions having relation with the question are arranged around the selected question. These questions are connected by links and expressed. Note that FIG. 9 illustrates a plurality of high-order questions having strong relation with the selected question. Note that, in relation to the number of the other questions to be displayed, for example, all the questions having a correlation amount equal to or more than a threshold may be displayed, or a limited number of high-order questions may be displayed in descending order of relation. This enables the user to easily grasp the other questions having strong relation with the selected question.

Furthermore, FIG. 9 illustrates a percentage of correct answers for each question in a circular graph format. Furthermore, FIG. 9 illustrates a predetermined percentage (%) between questions. Such a percentage indicates a percentage of students who erroneously answered the central question among students who correctly answered a surrounding question. Specifically, the percentage is information indicating that the students who correctly answered the surrounding question made a misstep at (erroneously answered) the central question. That is, the provision unit 36 provides, in screen display, misstep information indicating the percentage of the students who erroneously answered the selected question among students who correctly answered the other question having relation with the question selected by the user.

Moreover, although not illustrated, when the user further selects surrounding questions, a screen as illustrated in FIG. 9 centered on the selected question is displayed. This makes it possible to easily grasp at which question (learning field) the student made a misstep by sequentially tracing erroneously answered questions.

Note that FIG. 9 illustrates a case where ease of making a misstep is displayed in a probability value. For example, the display form such as color of a link having a probability value equal to or more than a threshold may be changed. Furthermore, in FIG. 9, questions having a plurality of high-order probability values may be arranged around and displayed.

Note that the screen example in FIG. 9 is one example, and may be expressed as, for example, the screen example in FIG. 10. Specifically, in FIG. 10, the selected question is located at the center, and the screen example is expressed by layer for each year.

In the example in FIG. 10, a question of Japanese language of the 3rd year of junior high is arranged in an upper layer of selected Question 3 of Japanese language of the 2nd year of junior high. Another question of Japanese language of the 2nd year of junior high is arranged in a middle layer (same layer) of Question 3. A question of the 1st year of junior high is arranged in a lower layer of Question 3. This makes it possible to easily grasp the year of another question having relation with the selected question.

Note that, in the screen example in FIG. 10, as illustrated in FIG. 9, each node may be expressed by a circular graph indicating a percentage of correct answers, and a probability value indicating ease of making a misstep may be displayed between nodes.

### 5. Variations

Note that, although, in the above-described embodiment, a case where relation between questions is estimated based on pieces of time series data on test results of students has been described, for example, relation between processes in a product manufacturing line may be estimated.

In such a case, the relation between processes is estimated by using data obtained in each process of a manufacturing line (product defect data and inspection data) as time series data and using each process as a period in divided data.

This makes it possible to facilitate quality control handling in a preceding process for a defect and a bug in a subsequent process in a predictive manner.

Furthermore, the present invention may be applied not only to the case where the relation between processes in a product manufacturing line is estimated but, for example, to a case where behavior analysis in online service and factor analysis of service continuation are estimated.

For example, pieces of information on behavior in service of a user in online service are acquired as pieces of time series data. Pieces of divided data are generated by dividing such pieces of behavior information for each predetermined period. Note that, any period such as year, month, day, hour, and minute can be set for such a period.

Then, a feature amount represented by the presence or absence of each behavior within each period is generated as a behavior index. Relation between service use and a behavior situation in time series can be estimated by generating a model indicating the relation by using the generated behavior index.

Moreover, a behavior contributing to service continuation from a long-term viewpoint can be extracted and visualized by adding an index serving as a goal such as the service continuation and estimating relation while looking back on each period.

### 6. Flowchart

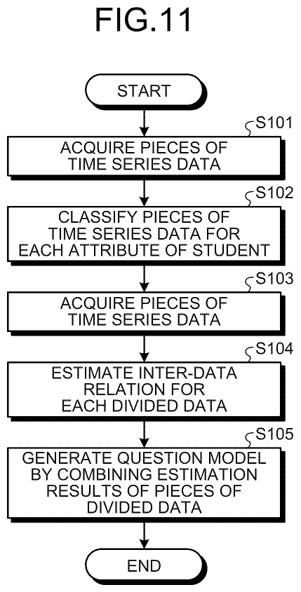

Next, a procedure of information processing executed by the information processing apparatus 1 according to the embodiment will be described with reference to FIGS. 11 to 13. FIGS. 11 to 13 are flowcharts illustrating the procedure of information processing executed by the information processing apparatus 1 according to the embodiment.

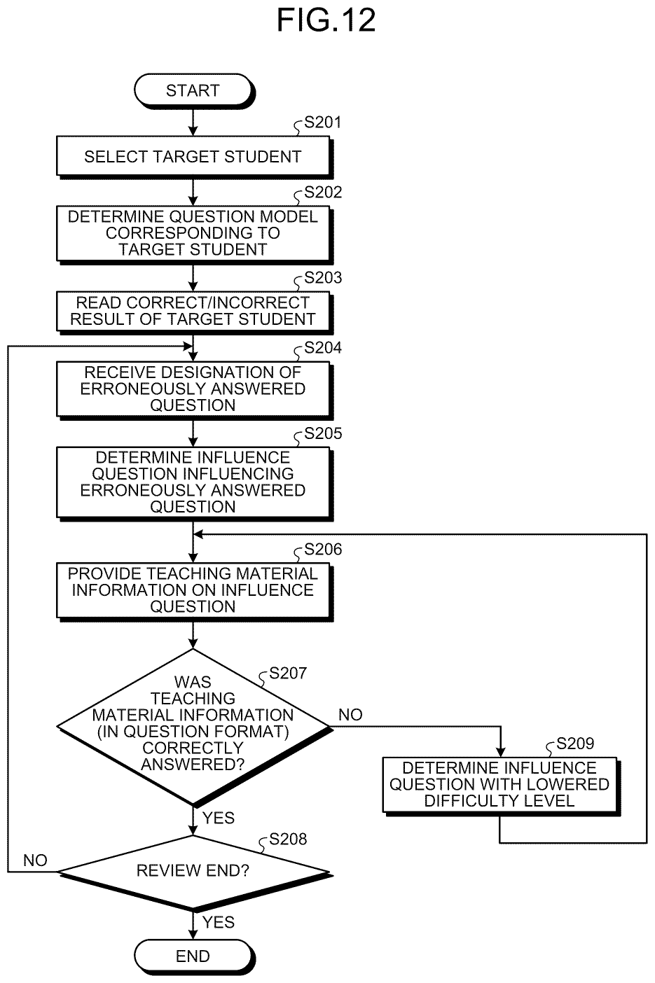

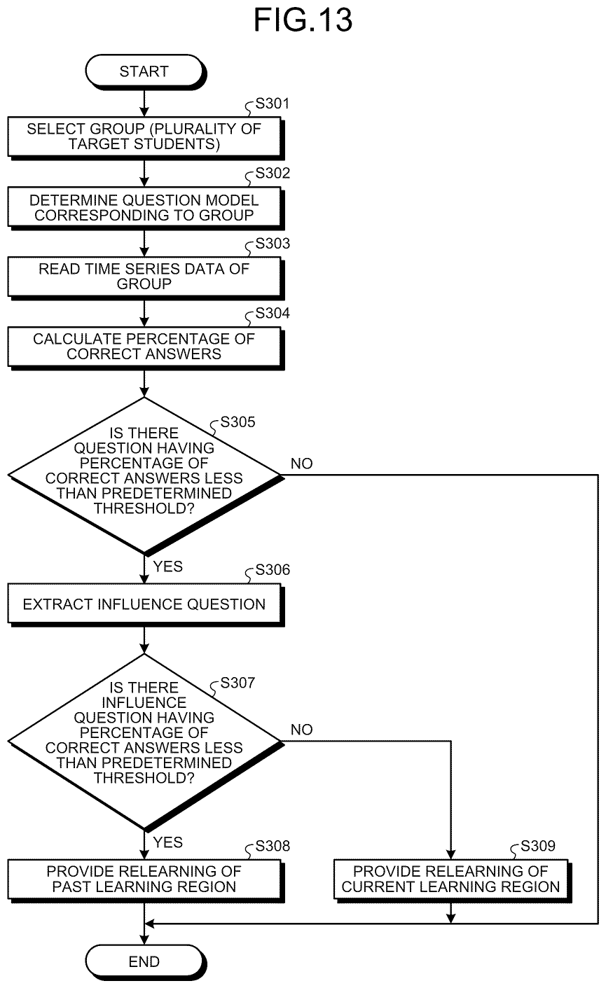

Note that FIG. 11 illustrates processing of generating a question model indicating inter-data relation between pieces of time series data (between test questions). FIG. 12 illustrates provision processing of providing teaching material information used at the time when a predetermined target student conducts a review. FIG. 13 illustrates provision processing of providing a lesson plan for a student group such as a class.

First, the processing of generating a question model will be described with reference to FIG. 11. As illustrated in FIG. 11, first, the acquisition unit 31 acquires pieces of time series data on a predetermined analysis target (Step S101). Subsequently, the generation unit 32 classifies the acquired pieces of time series data for each attribute of a student (Step S102). Note that the attribute includes, for example, a school, a region, and an academic level of the student.

Subsequently, the generation unit 32 generates pieces of divided data by dividing the pieces of time series data classified for each attribute for each predetermined period (Step S103). Subsequently, the estimation unit 33 estimates inter-data relation between the pieces of time series data for each divided data (Step S104).

Subsequently, the estimation unit 33 generates a question model by combining estimation results of the pieces of divided data (Step S105), and ends the processing.

Next, processing of providing teaching material information to a target student will be described with reference to FIG. 12. As illustrated in FIG. 12, first, the selection unit 34 selects a target student to which the teaching material information is to be provided (Step S201).

Subsequently, the determination unit 35 determines a question model corresponding to the attribute of the target student (Step S202). Subsequently, the determination unit 35 reads a correct/incorrect result for a test question, which is time series data of the target student, from the time series data 41 of the storage unit 4 (Step S203).

Subsequently, the determination unit 35 receives designation of an erroneously answered question from the target student via the terminal device 100 (Step S204). Subsequently, the determination unit 35 determines an influence question influencing the erroneously answered question based on the question model (Step S205).

Subsequently, the provision unit 36 provides teaching material information on the determined influence question (Step S206). Note that, here, teaching material information in a question format on the influence question is provided as the teaching material information.

Subsequently, the provision unit 36 determines whether or not the target student has correctly answered the provided teaching material information in the question format (Step S207). When the target student has reached a correct answer (Step S207: Yes), the provision unit 36 determines whether or not an operation indicating a review end has been received from the target student (Step S208).

When receiving the operation indicating the review end (Step S208: Yes), the provision unit 36 ends the processing. When receiving an operation indicating review continuation from the target student (Step S208: No), the provision unit 36 returns to Step S204.

In contrast, when the provision unit 36 has erroneously answered the teaching material information in Step S207 (Step S207: No), the determination unit 35 determines an influence question with a lowered difficulty level (Step S209), and returns to Step S206.

Next, provision processing of providing a lesson plan to a student group will be described with reference to FIG. 13. As illustrated in FIG. 13, first, the selection unit 34 selects a group such as a class which a user such as a teacher is in charge of, in other words, a plurality of target students belonging to the same group (Step S301).

Subsequently, the determination unit 35 determines a question model corresponding to the attribute of the group (Step S302). Subsequently, the determination unit 35 reads a correct/incorrect result of a test question, which is time series data of each of a plurality of target students included in the group, from the time series data 41 of the storage unit 4 (Step S303).

Subsequently, the determination unit 35 calculates a percentage of correct answers for each question in the group based on the read correct/incorrect result (Step S304). Subsequently, the determination unit determines whether or not there is a question having a percentage of correct answers less than a predetermined threshold (Step S305).

Subsequently, when there is a question having a percentage of correct answers less than a predetermined threshold (Step S305: Yes), the determination unit 35 extracts one or more influence questions influencing the question (Step S306). Note that, when there is not a question having a percentage of correct answers less than a predetermined threshold (Step S305: No), the determination unit 35 ends the processing.

Subsequently, the determination unit 35 determines whether or not there is an influence question having a percentage of correct answers less than a predetermined threshold among the extracted one or more influence questions (Step S307). When there is an influence question having a percentage of correct answers less than a predetermined threshold (Step S307: Yes), the provision unit 36 provides provision information indicating that relearning of a learning region of a past year corresponding to the influence question is effective (Step S308), and ends the processing.

In contrast, when there is not an influence question having a percentage of correct answers less than a predetermined threshold (Step S307: No), the provision unit 36 provides provision information indicating that relearning of a learning region of the current year corresponding to the erroneously answered question is effective (Step S309), and ends the processing.

### 7. Hardware Configuration Example

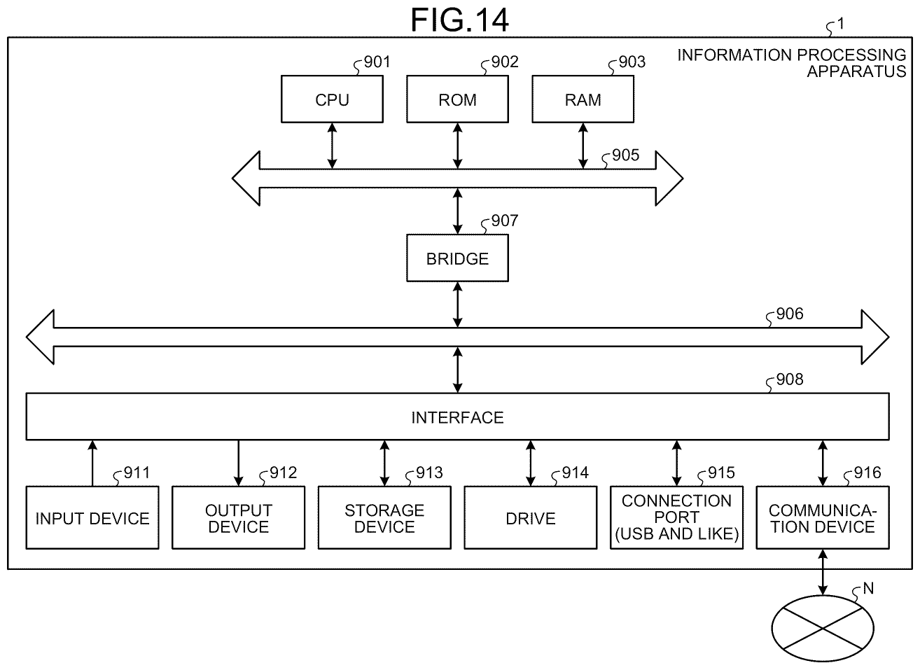

Subsequently, one example of a hardware configuration of the information processing apparatus 1 and the like according to the present embodiment will be described with reference to FIG. 14. FIG. 14 is a block diagram illustrating one example of a hardware configuration of the information processing apparatus 1 according to the present embodiment.

As illustrated in FIG. 14, the information processing apparatus 1 includes a central processing unit (CPU) 901, a read only memory (ROM) 902, a random access memory (RAM) 903, a host bus 905, a bridge 907, an external bus 906, an interface 908, an input device 911, an output device 912, a storage device 913, a drive 914, a connection port 915, and a communication device 916. The information processing apparatus 1 may include an electric circuit and a processing circuit such as a DSP and an ASIC instead of or in addition to the CPU 901.

The CPU 901 functions as an arithmetic processing device and a control device, and controls the overall operation in the information processing apparatus 1 in accordance with various programs. Furthermore, the CPU 901 may be a microprocessor. The ROM 902 stores programs, operation parameters, and the like used by the CPU 901. The RAM 903 temporarily stores programs used in execution of the CPU 901, parameters that appropriately change in the execution, and the like. For example, the CPU 901 may execute functions of the acquisition unit 31, the generation unit 32, the estimation unit 33, the selection unit 34, the determination unit 35, and the provision unit 36.

The CPU 901, the ROM 902, and the RAM 903 are mutually connected by the host bus 905 including a CPU bus and the like. The host bus 905 is connected to the external bus 906 such as a peripheral component interconnect/interface (PCI) bus via the bridge 907. Note that the host bus 905, the bridge 907, and the external bus 906 are not necessarily separated, and these functions may be mounted on one bus.

The input device 911 is used for a user to input information, such as a mouse, a keyboard, a touch panel, a button, a microphone, a switch, and a lever. Alternatively, the input device 911 may be a remote-control device using infrared rays or other radio waves, or may be an external connection device, such as a mobile phone and a PDA, supporting operation of the information processing apparatus 1. Moreover, for example, the input device 911 may include an input control circuit and the like, which generates an input signal based on information input by a user by using the above-described input instrument.

The output device 912 can visually or auditorily notifying the user of information. For example, the output device 912 may be a display device such as a cathode ray tube (CRT) display device, a liquid crystal display device, a plasma display device, an electroluminescence (EL) display device, a laser projector, a light emitting diode (LED) projector, and a lamp, or may be a voice output device such as a speaker and a headphone.

The output device 912 may output results obtained by various pieces of processing performed by the information processing apparatus 1, for example. Specifically, the output device 912 may visually display the results obtained by various pieces of processing performed by the information processing apparatus 1 in various formats such as text, an image, a table, and a graph. Alternatively, the output device 912 may convert an audio signal such as voice data and acoustic data into an analog signal, and auditorily output the analog signal. The input device 911 and the output device 912 may execute a function of, for example, an interface.

The storage device 913 is formed as one example of the storage unit 4 of the information processing apparatus 1, and stores data. The storage device 913 may be implemented by, for example, a magnetic storage device such as a hard disc drive (HDD), a semiconductor storage device, an optical storage device, and a magneto-optical storage device. The storage device 913 may include, for example, a storage medium, a recording device, a reading device, and a deletion device. The recording device records data in the storage medium. The reading device reads data from the storage medium. The deletion device deletes data recorded in the storage medium. The storage device 913 may store programs executed by the CPU 901, various pieces of data, various pieces of data acquired from the outside, and the like. The storage device 913 may execute, for example, a function of storing the time series data 41 and the user information 42.

The drive 914 is a reader/writer for a storage medium, and is built in or externally attached to the information processing apparatus 1. The drive 914 reads information recorded in a removable storage medium mounted on the drive 914 itself, such as a magnetic disk, an optical disk, a magneto-optical disk, and a semiconductor memory, and outputs the information to the RAM 903. Furthermore, the drive 914 can also write information to the removable storage medium.

The connection port 915 is an interface connected to an external device. Data can be transmitted to and received from the external device through the connection port 915. The connection port 915 may be, for example, a universal serial bus (USB).

The communication device 916 is an interface formed by, for example, a communication device for connection with a network N. The communication device 916 may be, for example, a communication card for a wired or wireless local area network (LAN), long term evolution (LTE), Bluetooth (registered trademark), and a wireless USB (WUSB). Furthermore, the communication device 916 may be a router for optical communication, a router for an asymmetric digital subscriber line (ADSL), a modem for various pieces of communication, and the like. For example, the communication device 916 can transmit and receive a signal and the like over the Internet or to and from other communication devices in accordance with a predetermined protocol such as TCP/IP.

Note that the network N is a wired or wireless transmission path for information. For example, the network N may include a public network such as the Internet, a telephone network, and a satellite communication network, various local area networks (LANs) including Ethernet (registered trademark), and a wide area network (WAN). Furthermore, the network N may include a dedicated network such as an internet protocol-virtual private network (IP-VPN).

Note that it is also possible to create a computer program for causing hardware such as a CPU, a ROM, and a RAM built in the information processing apparatus 1 to exhibit a function equivalent to that of each of the configurations of the information processing apparatus 1 according to the above-described present embodiment. Furthermore, a storage medium storing the computer program can also be provided.

Furthermore, among pieces of processing described in the above-described embodiment, all or part of processing described as being performed automatically can be performed manually, or all or part of processing described as being performed manually can be performed automatically by a known method. In addition, the processing procedures, specific names, and information including various pieces of data and parameters in the above document and drawings can be optionally changed unless otherwise specified. For example, various pieces of information in each figure are not limited to the illustrated information.

Furthermore, each component of each illustrated device is functional and conceptual, and does not necessarily need to be physically configured as illustrated. That is, the specific form of distribution/integration of each device is not limited to the illustrated form, and all or part of the device can be configured in a functionally or physically distributed/integrated manner in any unit in accordance with various loads and usage situations.

Furthermore, the above-described embodiment can be appropriately combined in a region where the processing contents do not contradict each other. Furthermore, the order of steps in the flowcharts or the sequence diagrams of the above-described embodiment can be appropriately changed.

### 8. Conclusion

As described above, according to one embodiment of the present disclosure, the information processing apparatus 1 includes the generation unit 32 and the estimation unit 33. The generation unit 32 generates pieces of divided data by dividing pieces of time series data on a predetermined analysis target for each predetermined period. The estimation unit 33 estimates relation between pieces of data included in the divided data generated by the generation unit 32.

Therefore, relation useful for a user can be estimated by estimating relation along a time order in a time series, so that accuracy of estimating relation can be enhanced.

Furthermore, the generation unit 32 generates pieces of divided data divided such that partial periods of predetermined periods overlap with each other. The estimation unit 33 combines estimation results for pieces of divided data based on data of a partial overlapping periods.

This enables a plurality of pieces of divided data to be combined to one relation model, so that the user can grasp relation across the pieces of divided data, for example.

Furthermore, the time series data includes information on a comprehension level of each of a plurality of students belonging to an educational facility. The generation unit 32 generates divided data divided by a predetermined period corresponding to an educational unit of the educational facility.

This enables the relation to be estimated in an order of learnings built along the educational unit, so that the student can grasp appropriate relation along the learning order.

Furthermore, the generation unit 32 generates divided data for each attribute of the student.

This enables the estimation result of the estimation unit 33 in the subsequent stage to reflect features/characteristics of the attribute of the student.

Furthermore, the time series data includes information on a comprehension level in each of a plurality of learning fields. The estimation unit 33 estimates relation between pieces of time series data in the same learning field and relation between pieces of time series data in different learning fields.

This enables the user to grasp relation in a range beyond a learning field.

Furthermore, the time series data includes correct/incorrect results of a plurality of questions answered by the student. The estimation unit 33 estimates relation between a plurality of questions.

This enables the user (student or teacher) to grasp the relation between the questions answered by the student.

Furthermore, the selection unit 34 selects any student from a plurality of students as a target student. The determination unit 35 determines an influence question among a plurality of questions based on the relation estimated by the estimation unit 33. The influence question influences an erroneously answered question erroneously answered by the target student.

This enables the influence question influencing the erroneously answered question to be determined with high accuracy.

Furthermore, the time series data includes information on the difficulty level of a question. The determination unit 35 determines a question having a difficulty level lower than that of the erroneously answered question as an influence question.

This can inhibit a decrease in motivation of the student due to a high difficulty level of teaching material information based on the influence question.

Furthermore, the provision unit 36 provides teaching material information on the influence question determined by the determination unit 35.

This enables a question, which causes an erroneous answer for a question erroneously answered by a student, to be provided to the student as teaching material information, so that efficient learning of the student can be supported.

Furthermore, the provision unit 36 provides relation between a plurality of questions estimated by the estimation unit 33 by screen display.

This enables a user such as a student and a teacher to easily grasp relation between questions.

Furthermore, the provision unit 36 provides the presence or absence of relation between a plurality of questions and the strength of the relation by screen display.

This enables the presence or absence of relation and the strength of the relation to be expressed by visual changes, so that the user can easily grasp the estimation results of the estimation unit 33.

Furthermore, in the screen display, the provision unit 36 sets each of the plurality of questions as a node, connects questions having relation with a link, and expresses the link in a display mode in accordance with the strength of the relation.

This enables the presence or absence of relation and the strength of the relation to be expressed by visual changes, so that the user can easily grasp the estimation results of the estimation unit 33.

Furthermore, the provision unit 36 provides, in screen display, misstep information indicating the percentage of students who erroneously answered the selected question among students who correctly answered the other question having relation with the question selected by the user.

This enables a tendency for the student to make a misstep to be easily grasped.

Furthermore, the selection unit 34 selects a plurality of target students. The determination unit 35 determines an influence question influencing a question having a percentage of correct answers of the plurality of target students less than a predetermined threshold based on correct/incorrect results of a question.

This enables a teaching material based on an influence question in a learning region for which many students have insufficient understanding to be provided, which can assist a learning plan for a plurality of students such as a class, for example.

Although the embodiment of the present disclosure has been described above, the technical scope of the present disclosure is not limited to the above-described embodiment as it is, and various modifications can be made without departing from the gist of the present disclosure. Furthermore, components of different embodiments and variations may be appropriately combined.

Furthermore, the effects in the embodiment described in the present specification are merely examples and not limitations. Other effects may be exhibited.

Note that the present technology can also have the configurations as follows.

(1)

An information processing apparatus comprising:
a generation unit that generates pieces of divided data by dividing pieces of time series data on a predetermined analysis target for each predetermined period; and
an estimation unit that estimates relation between pieces of data included in each of the pieces of divided data generated by the generation unit.
   (2)

The information processing apparatus according to the above-described (1),
wherein the generation unit generates the pieces of divided data divided such that partial periods of predetermined periods overlap with each other, and
the estimation unit combines estimation results of the pieces of divided data based on data of an overlapping partial period.
   (3)

The information processing apparatus according to the above-described (1) to (2),
wherein the pieces of time series data include information on a comprehension level of each of a plurality of students belonging to an educational facility, and
the generation unit generates the pieces of divided data divided by the predetermined period corresponding to an educational unit of the educational facility.
   (4)

The information processing apparatus according to the above-described (3),
wherein the generation unit generates the pieces of divided data for an attribute of a student.
   (5)

The information processing apparatus according to the above-described (3) to (4),
wherein the pieces of time series data include information on the comprehension level in each of a plurality of learning fields, and
the estimation unit estimates the relation between the pieces of time series data in a same learning field and the relation between the time series data in different learning fields.
   (6)

The information processing apparatus according to the above-described (3) to (5),
wherein the pieces of time series data include a correct/incorrect result for each of a plurality of questions answered by the student, and
the estimation unit estimates the relation between the plurality of questions.
   (7)

The information processing apparatus according to the above-described (6), further comprising:
a selection unit that selects any student from the plurality of students as a target student, and
a determination unit that determines an influence question influencing an erroneously answered question erroneously answered by the target student based on the relation estimated by the estimation unit.
   (8)

The information processing apparatus according to the above-described (7),
wherein the pieces of time series data include information on difficulty levels of the questions, and
the determination unit determines a question having a difficulty level lower than that of the erroneously answered question as the influence question.
   (9)

The information processing apparatus according to the above-described (7) to (8), further comprising
a provision unit that provides teaching material information on the influence question determined by the determination unit.
   (10)

The information processing apparatus according to the above-described (6) to (9), further comprising
a provision unit that provides, by screen display, the relation between the plurality of questions estimated by the estimation unit.
   (11)

The information processing apparatus according to the above-described (10),
wherein the provision unit provides, by the screen display, presence or absence of the relation between the plurality of questions and strength of the relation.
   (12)

The information processing apparatus according to the above-described (11),
wherein the provision unit, in the screen display, sets each of the plurality of questions as a node, connects questions having the relation with a link, and expresses the link in a display mode in accordance with the strength of the relation.
   (13)

The information processing apparatus according to the above-described (10) to (12),
wherein the provision unit provides, in the screen display, misstep information indicating a percentage of students who erroneously answered a question selected by a user among students who correctly answered another question having relation with the question selected.
   (14)

The information processing apparatus according to the above-described (7) to (13),
wherein the selection unit selects a plurality of target students, and
the determination unit determines the influence question influencing a question having a percentage of correct answers of the plurality of target students less than a predetermined threshold based on the correct/incorrect result.
   (15)

An information processing method including:
an acquisition process of acquiring pieces of time series data on a predetermined analysis target;
a generation process of generating pieces of divided data by dividing the pieces of time series data acquired in the acquisition process for each predetermined period; and
an estimation process of estimating relation between pieces of data included in each of the pieces of divided data generated in the generation process.
   (16)

An information processing program causing a computer to execute:
an acquisition procedure of acquiring pieces of time series data on a predetermined analysis target;
a generation procedure of generating pieces of divided data by dividing the pieces of time series data acquired by the acquisition procedure for each predetermined period; and
an estimation procedure of estimating relation between pieces of data included in each of the pieces of divided data generated by the generation procedure.

### REFERENCE SIGNS LIST

1 INFORMATION PROCESSING APPARATUS
2, 200 COMMUNICATION UNIT
3, 500 CONTROL UNIT
4, 600 STORAGE UNIT
31 ACQUISITION UNIT
32 GENERATION UNIT
33 ESTIMATION UNIT
34 SELECTION UNIT
35 DETERMINATION UNIT
36 PROVISION UNIT
41 TIME SERIES DATA
42 USER INFORMATION
100 TERMINAL DEVICE
300 DISPLAY UNIT
400 INPUT UNIT
S INFORMATION PROCESSING SYSTEM

1. An information processing apparatus comprising:
a generation unit that generates pieces of divided data by dividing pieces of time series data on a predetermined analysis target for each predetermined period; and
an estimation unit that estimates relation between pieces of data included in each of the pieces of divided data generated by the generation unit.

2. The information processing apparatus according to claim 1,
wherein the generation unit generates the pieces of divided data divided such that partial periods of predetermined periods overlap with each other, and
the estimation unit combines estimation results of the pieces of divided data based on data of an overlapping partial period.

3. The information processing apparatus according to claim 1,
wherein the pieces of time series data include information on a comprehension level of each of a plurality of students belonging to an educational facility, and
the generation unit generates the pieces of divided data divided by the predetermined period corresponding to an educational unit of the educational facility.

4. The information processing apparatus according to claim 3,
wherein the generation unit generates the pieces of divided data for an attribute of a student.

5. The information processing apparatus according to claim 3,
wherein the pieces of time series data include information on the comprehension level in each of a plurality of learning fields, and
the estimation unit estimates the relation between the pieces of time series data in a same learning field and the relation between the time series data in different learning fields.

6. The information processing apparatus according to claim 3,
wherein the pieces of time series data include a correct/incorrect result for each of a plurality of questions answered by the student, and
the estimation unit estimates the relation between the plurality of questions.

7. The information processing apparatus according to claim 6, further comprising:
a selection unit that selects any student from the plurality of students as a target student, and
a determination unit that determines an influence question influencing an erroneously answered question erroneously answered by the target student based on the relation estimated by the estimation unit.

8. The information processing apparatus according to claim 7,
wherein the pieces of time series data include information on difficulty levels of the questions, and
the determination unit determines a question having a difficulty level lower than that of the erroneously answered question as the influence question.

9. The information processing apparatus according to claim 7, further comprising
a provision unit that provides teaching material information on the influence question determined by the determination unit.

10. The information processing apparatus according to claim 6, further comprising
a provision unit that provides, by screen display, the relation between the plurality of questions estimated by the estimation unit.

11. The information processing apparatus according to claim 10,
wherein the provision unit provides, by the screen display, presence or absence of the relation between the plurality of questions and strength of the relation.

12. The information processing apparatus according to claim 11,
wherein the provision unit, in the screen display, sets each of the plurality of questions as a node, connects questions having the relation with a link, and expresses the link in a display mode in accordance with the strength of the relation.

13. The information processing apparatus according to claim 10,
wherein the provision unit provides, in the screen display, misstep information indicating a percentage of students who erroneously answered a question selected by a user among students who correctly answered another question having relation with the question selected.

14. The information processing apparatus according to claim 7,
wherein the selection unit selects a plurality of target students, and
the determination unit determines the influence question influencing a question having a percentage of correct answers of the plurality of target students less than a predetermined threshold based on the correct/incorrect result.

15. An information processing method comprising:
a generation process of generating pieces of divided data by dividing pieces of time series data on a predetermined analysis target for each predetermined period; and
an estimation process of estimating relation between pieces of data included in each of the pieces of divided data generated in the generation process.

16. An information processing program causing a computer to execute:
a generation procedure of generating pieces of divided data by dividing pieces of time series data on a predetermined analysis target for each predetermined period; and
an estimation procedure of estimating relation between pieces of data included in each of the pieces of divided data generated by the generation procedure.
